(19) United States
(12) Patent Application Publication
(10) Pub. No.: US 2026/0259977 A1
(43) Pub. Date: Sep. 3, 2026

(54) METHOD FOR EMBEDDING AN APPLICATION IN A REAL-TIME ENVIRONMENT

(71) Applicants: Robert Bosch GmbH, Stuttgart (DE); CARNEGIE MELLON UNIVERSITY, Pittsburgh, PA (US)

(72) Inventors: Anthony Rowe, Pittsburgh, PA (US); Arne Hamann, Ludwigsburg (DE); Dakshina Narahari Dasari, Renningen (DE); Franz-Josef Grosch, Darmstadt (DE); Nuno Pereira, Pittsburgh, PA (US)

(21) Appl. No.: 19/148,122

(22) PCT Filed: Jan. 9, 2024
(86) PCT No.: PCT/EP2024/050317

§ 371 Date: Jul. 15, 2025

(30) Foreign Application Priority Data
Feb. 17, 2023 (DE) 10 2023 201 397.5

(51) Int. Cl. G06F 21/53; B60W 50/00; G05B 19/05; G06F 21/54

(52) U.S. Cl. CPC G06F 21/53; B60W 50/0098; G05B 19/056; G06F 21/54; B60W 2556/45; G05B 2219/13004; G06F 2221/033

(57) ABSTRACT

A method for embedding at least one application in a real-time environment, the real-time environment being provided by a programmable logic controller. The method includes receiving the at least one application, the at least one application being received as an intermediate representation; providing a sandbox for the at least one received application; executing the at least one sandboxed application, the executing being carried out based on an interpretation of the at least one sandboxed application using a virtualization runtime of the real-time environment, the intermediate representation being augmented by the runtime to provide at least one real-time and/or safety function for the at least one sandboxed application.

### FIELD

The present invention relates to a method for embedding at least one application in a real-time environment. Furthermore, the present invention relates to a computer program as well as a data processing apparatus.

### BACKGROUND INFORMATION

Programmable Logic Controllers, also referred to as PLCs, are embedded computers tailored to control industrial processes. A common architecture of PLC software is to use a real-time operating system, short OS, to predictably execute the PLC system software, also referred to as the PLC runtime. The PLC runtime is responsible for running the PLC control logic. The PLC control logic is executed inside a scan cycle managed by the PLC runtime: it scans the inputs 55 and outputs 50 (short IOs) to update the internal variable table, executes the control logic and updates the resulting IOs. The PLC control logic is continuously executing this scan cycle. This architecture is widely used in modern industrial manufacturing facilities to control safety-critical industrial control systems (ICS).

Because the PLC control logic is executed by the PLC runtime, a realization of multiprogramming inside the PLC is difficult. All code executed by the PLC runtime must be trusted, and a faulty component (e. g., causing a runtime error) can compromise and tear down the entire system. While the PLC runtime can be made robust to some faults, this usually means that the PLC control logic must be trusted to some degree and, for this reason, PLC programs are usually generated from specific programming models (such as ladder, function block diagrams, or structured text) that preclude modern programming languages and tend to limit functional complexity and expressiveness to reduce the likelihood of introducing critical errors into the PLC programs. PLC runtimes that do support general purpose languages for advanced use cases must be carefully developed and debugged by highly specialized developers to avoid compromising the entire PLC system. This is a costly and error-prone process.

### SUMMARY

According to aspects of the present invention, a method, a computer program, and a data processing apparatus are provided. Features and details of the present invention are disclosed herein. Features and details described in the context of the method also correspond to the computer program as well as the data processing apparatus, and vice versa in each case.

An aspect of the present invention comprises a method for embedding at least one application in a real-time environment. The real-time environment may be provided by a programmable logic controller, also referred to as PLC, particularly so that the PLC may be used to execute the at least one application. The application may be configured as a program for the PLC.

According to an example embodiment of the present invention, the method may comprise receiving the at least one application, particularly by the real-time environment, preferably the PLC. The at least one application may be received as an intermediate representation, particularly bytecode. Furthermore, the method may comprise providing a sandbox for the at least one application, particularly received application. In other words, the application may be sandboxed. Therefore, the method may also comprise applying the sandbox to the at least one application.

Furthermore, according to an example embodiment of the present invention, the method may comprise executing the at least one sandboxed application. In other words, the application may be run, particularly by the PLC. The executing may be carried out based on an interpretation of the at least one sandboxed application using, particularly by, a virtualization runtime of the real-time environment. The intermediate representation may be augmented by the runtime to provide at least one real-time and/or safety function for the at least one sandboxed application. The augmentation may be possible by injecting code into the intermediate representation, particularly bytecode, which provides the real-time and/or safety function. The real-time function may be used to enable the application to be executed under real-time conditions. The safety function may enable a safer execution of the application, e.g., by providing redundancy capabilities. The present invention may thereby allow to provide a mechanism for embedding critical applications into a runtime. In the context of the present invention, the virtualization runtime or shortly referred to as runtime may also be referred to as SafeRT (for “safe runtime”) and/or as runtime environment and/or system software. The proposed mechanism may allow to further leverage WASM, also referred to as WebAssembly, which is a conventional standard for defining a portable binary-code format and a corresponding text format for executable programs as well as software interfaces for facilitating interactions between such programs and their host environment.

The augmenting, particularly also referred to as code injecting, may allow an instrumentation of the application. For example, the safety function may allow multiple versions of the application to be executed in the virtualization runtime to provide redundancy of the application. Furthermore, the real-time and/or safety function may provide redundancy of the application and/or monitoring the application and/or analysing the application and/or a watchdog for the application. SafeRT may therefore provide additional safety protections by redundant execution of functionally equivalent, automatically generated versions of the at least one application across heterogeneous hardware architectures. Furthermore, SafeRT may use injected monitoring and assertion code in the application, particularly PLC program logic, to continuously analyse the data and control flow. This can be used to detect and react to faults and attacks.

It is possible that the intermediate representation is a bytecode, particularly WebAssembly. In other words, applications executed by SafeRT may be compiled into WASM. This allows ergo code analysis and transformations to check and enforce program properties and/or to inject monitoring and assertions to enforce properties and and/or to generate different program versions to be executed redundantly.

The virtualization runtime may provide a virtualization mechanism to safely embed application, particularly programs, in PLC runtime systems. To this end, the virtualization runtime may accept and interpret intermediate bytecode representations of a program.

The real-time environment may be configured as a hardware device, particularly an embedded computer, preferably a Programmable Logic Controller.

It is possible that the augmentation of the intermediate representation by the runtime comprises injecting monitoring and/or assertion code into the intermediate representation, particularly bytecode, to provide the at least one real-time and/or safety function, particularly to detect and prevent faults and attacks, wherein preferably different versions of the sandboxed application are generated and executed redundantly. A compliance checker may be used to inject the code. The compliance checker may be configured as a software and/or hardware component of the real-time environment. The method according to the present invention may provide software fault isolation between different applications, particularly PLC programs, and support general purpose languages to be safely executed within the PLC runtime and to guarantee real-time properties of the programs. Additionally, the method according to the present invention may facilitate redundant execution of PLC programs, which can be used to detect faults. These properties may be achieved using a common intermediate representation of PLC programs (WASM) and by performing code analysis and transformations to guarantee properties at runtime. Another feature of the mechanism provided by the present invention may be leveraging the common intermediate representation of PLC programs to detect and mitigate attacks on the control system by injecting monitoring and assertion code into the program logic.

According to an example embodiment of the present invention, it is further possible that the runtime provides a multiprogramming environment for performing the execution of multiple of the at least one sandboxed application at the same time. In other words, the at least one application may comprise multiple applications, for example at least two or at least three applications, which may run at the same time.

Also, the runtime may be configured to provide a software fault isolation between the sandboxed application and further applications running in the real-time environment and/or between the multiple sandboxed applications. The method according to the present invention may thereby provide a safe multiprogramming environment for the PLC runtime. This enables multiple programs to co-exist through software fault isolation that does not allow faults to propagate to other programs or the rest of the system. Another advantage of the present invention may be to provide a support for general-purpose languages, like a variety of general-purpose languages (e. g. C, C++), with safety guarantees offered by the system and with no or little developer burden.

Furthermore, a fine-grained system access may be provided. The virtualization runtime may follow a capability-based execution model. That is, programs are denied access to resources by default, and are only granted access to the system resources they strictly need to execute. The runtime may therefore include system access primitives tailored to the industrial automation domain to provide fine access to specific devices (modules, drives, etc).

Another advantage may be an advanced fault resilience. The method according to the present invention may provide additional safety protections by redundant execution of functionally equivalent, automatically generated, versions of the applications across heterogeneous HW (i. e., hardware) architectures. Also, an advanced fault and attack detection may be provided. The method according to the present invention may use injected monitoring and assertion code in the PLC program logic to continuously analyse the data and control flow. This can be used to detect and react to faults and attacks.

Also, secure updates may be provided since the applications can include their code and a specification of program properties.

According to another advantage of the present invention, real-time aware orchestration may be provided. To this end, a continuous monitoring of the resource usage of the applications may be provided. The underlying operating system (e.g., the scheduling parameters) may then be configured to ensure their timely and predictable execution. This feature can be crucial to account for different importance and QoS requirements among the applications as well as to enable the addition of new applications on-the-fly in a running system.

According to an example embodiment of the present invention, it is possible that a system interface is provided to allow the sandboxed application a controlled access to resources in an industrial control system. It is also possible that multiple versions of the sandboxed application are executed by the runtime. A runtime voting mechanism may be provided to check results the multiple versions, particularly to provide redundancy of the sandboxed application. The runtime voting mechanism may be provided by a redundancy module. Alternatively, or additionally, according to the method of the present invention, the following components may be provided:
a runtime component, also referred to as SafeRT WASM Runtime, which is configured to execute the sandboxed applications,
a system interface, also referred to as SafeRT system interface, which is configured to allow controlled access to resources in an industrial control system,
a compliance checker, also referred to as SafeRT compliance checker, which is configured to provide a compile-time tool that injects monitoring and assertion code snippets into the applications that are used at runtime to detect and prevent faults (such as runtime errors) and attacks,
a redundancy module, also referred to as SafeRT redundancy module, which is configured to provide a compile-time tool coupled with a runtime voting mechanism to support application redundancy across heterogeneous HW architectures.

Furthermore, the sandboxed application may be configured as a safety-relevant application, particularly for automatically controlling a vehicle. The vehicle may be configured as a motor vehicle and/or passenger vehicle and/or autonomous vehicle for autonomous driving.

In another aspect of the present invention a computer program may be provided, in particular a computer program product, comprising instructions which, when the computer program is executed by a computer, cause the computer to carry out the method according to the present invention. Thus, the computer program according to the present invention can have the same advantages as have been described in detail with reference to a method according to the present invention.

In another aspect of the present invention an apparatus for data processing, also referred to as data processing apparatus, may be provided, which is configured to execute the method according to the present invention. As the apparatus, for example, a computer can be provided which executes the computer program according to the present invention. The computer may include at least one processor that can be used to execute the computer program. Also, a non-volatile data memory may be provided in which the computer program may be stored and from which the computer program may be read by the processor for being carried out.

According to another aspect of the present invention a computer-readable storage medium may be provided which comprises the computer program according to the present invention. The storage medium may be formed as a data storage device such as a hard disk and/or a non-volatile memory and/or a memory card and/or a solid-state drive. The storage medium may, for example, be integrated into the computer.

Furthermore, the method according to the present invention may be implemented as a computer-implemented method.

Further advantages, features and details of the present invention will be apparent from the following description, in which embodiments of the present invention are described in detail with reference to the figures. In this context, the features mentioned in the description may each be essential to the present invention individually or in any combination.

### BRIEF DESCRIPTION OF THE DRAWINGS

FIG. 1 shows a method, computer program, and apparatus according to example embodiments of the present invention.

FIG. 2-6 show further exemplarily visualizations of example embodiments of the present invention.

### DETAILED DESCRIPTION OF EXAMPLE EMBODIMENTS

In the following figures, the identical reference signs are used for the same technical features even of different embodiment examples.

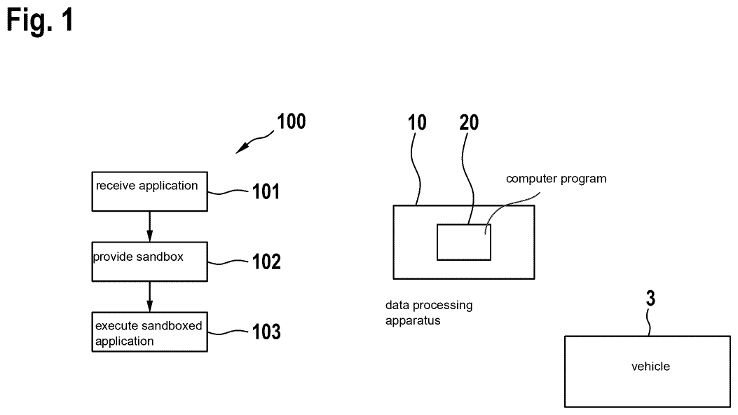

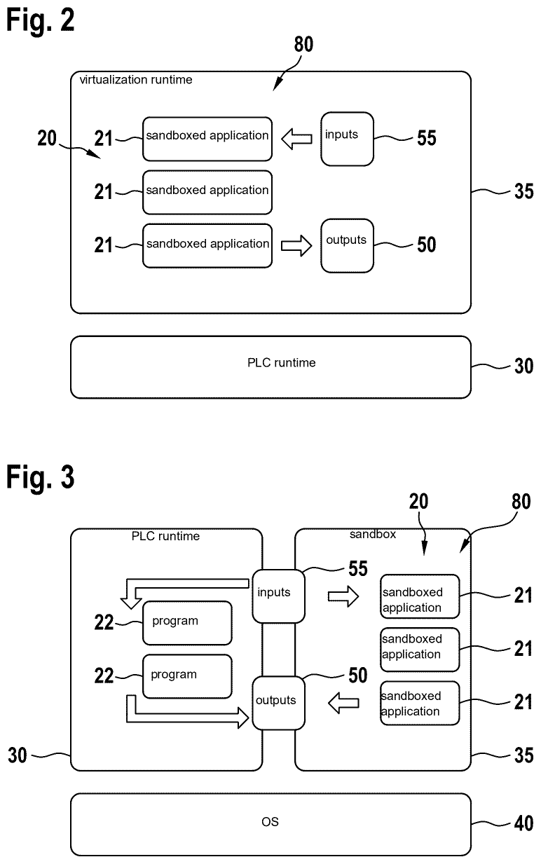

FIG. 1 shows a method 100 according to embodiments of the present invention. The method 100 may be used for embedding at least one application 20 in a real-time environment, as shown in FIG. 2-6. The real-time environment may be provided by a programmable logic controller 31. According to a first method step 101, the at least one application 20 may be received, wherein the at least one application 20 may be received as an intermediate representation. In other words, the at least one application 20 may be provided in a bytecode format allowing the same code to run cross-platform, i.e., on different devices. The intermediate representation and particularly bytecode may be a form of instruction set designed for efficient execution by a software interpreter. According to a second method step 102, a sandbox 80 may be provided for the at least one received application 20. Then, according to a third method step 103, the at least one sandboxed application 21 may be executed, particularly executed within the sandbox, wherein the executing 103 may be carried out based on an interpretation of the at least one sandboxed application 21, particularly its intermediate representation (bytecode), using a virtualization runtime 35 of the real-time environment. The intermediate representation may further be augmented by the virtualization runtime 35 to provide at least one real-time and/or safety function for the at least one sandboxed application 21.

Embodiments of the present inventions use lightweight virtualization mechanisms to safely embed programs in PLC runtime systems. This, however, requires an environment where access to memory, I/O, and processing time can be limited without the overhead associated with traditional OS system call-chains or full-scale virtual machines. Lightweight virtualization runtimes can accept and interpret intermediate bytecode representations of a program that can be generated from a wide variety of source languages. The intermediate bytecode can be augmented, i.e., modified, before converting it to raw machine code 65 (“Ahead-of-time” or “Just-in-time”) to allow hooks for resource metering, replication, and usage limiting without specialized hardware. One example of a safe and secure runtime target that is well suited for PLC environments is WebAssembly (Wasm), but there are other similar process-style virtual machines with intermediate languages like eBPF, JVM, and the LLVM IR.

Wasm is a binary instruction format for a stack-based virtual machine. It is a safe, fast, and portable low-level bytecode format that is designed for efficient validation and compilation, and safe execution with low to no overhead. Wasm also provides software-based fault isolation in terms of memory safety and control-flow integrity. It prevents accesses to memory outside its sandbox by restricting loads and stores to linear memory and ensures that branches/jumps in the code only go to intended addresses. It prevents buffer overflows with the help of a separate data stack and overriding of function pointers by calling function references only from a table of checked functions.

Furthermore, a system interface 36 may be provided to allow the sandboxed application 21 a controlled access to resources in an industrial control system 5. Also, the sandboxed application 21 may be configured as a safety-relevant application 20, particularly for automatically controlling a vehicle 3.

FIG. 1 also shows a computer program 20 and a data processing apparatus 10 according to embodiments of the present invention.

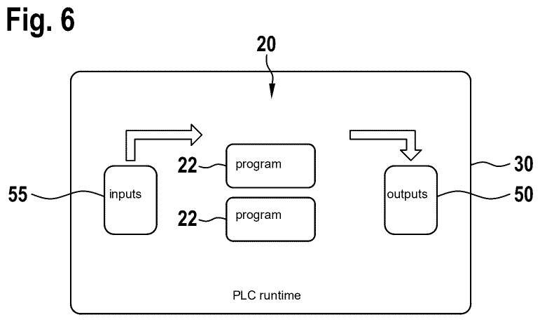

During the execution of the applications, particularly PLC programs, conventional solutions usually provide no mechanisms to check against program safety violations, such as memory access violations, malicious access to resources certain files, sockets, buffer overflows. The method according to embodiments of the present invention aims to create an execution environment for PLC programs that eases the development of such programs, leading to shorter development times, and support safety and security properties. Specifically, embodiments of the present invention may provide at least one of the following:
A mechanism to allow PLC runtimes to execute multiple programs created independently, guaranteeing they do not interfere with each other and that faults do not propagate to other programs nor the system.
A mechanism to provide co-existence of mixed criticality applications: Trusted applications can be directly deployed while untrusted applications can be sandboxed using the mechanism presented.
Ease development of PLC programs: Current development of PLC programs provides relatively restricted environments to develop programs. Partially due to the need to generate programs that do not jeopardize the entire system and the lack of mechanisms to protect against faults in these programs.
Automated software redundancy to automatically execute multiple versions of the same PLC program for fault detection. Moreover, using a lightweight virtualization approach proposed, heterogeneous redundancy is also easy to realize, as the same virtualized PLC program can be run on different hardware architectures (e.g., Intel and ARM) without modifications. This can, for instance, be leveraged on SoCs comprising different heterogeneous compute engines (e.g., μCs and μps).
Fine-grained virtualization of PLC programs: While virtualized PLC can facilitate moving entire PLC environments from the device to the (Edge-) Cloud, the proposed mechanism goes further into the PLC infrastructure and can provide finer granularity (moving individual programs) at a much-reduced overhead through platform-agnostic lightweight sandboxing.
Real-time aware orchestration: PLC systems implement the scan cycle as shown in FIG. 6 that executes all PLC programs sequentially in an equal manner. There is, thus, no possibility to distinguish different levels of importance and QoS requirements among different PLC programs. The proposed mechanisms allow the provision of system resources (e. g., CPU time) according to the individual real-time requirements of the PLC programs executed in the system.
Furthermore, a compliance checker 70 and a mechanism for automated code redundancy 75 may be provided.

FIG. 2 shows an embodiment according to the present invention, where multiple applications 20 are executed using the proposed runtime 35 (SafeRT) which, to this end, exemplarily provides a Wasm-based sandbox 80 for each program 21. FIG. 3 shows another embodiment of the present invention, where the proposed runtime 35 co-exists with one or more PLC Runtimes 30. This is a more complex scenario where programs 21 executed by the proposed runtime share IO with the PLC Runtimes through a shared memory (shm) mechanism. In this scenario, it may be necessary to protect the IO from data races and it is possible to do so by means of an IO Manager that only allows IO to be read/written from one of the runtimes 30, 35. That is, if an IO variable is being accessed by the PLC runtime 30, it may become read-only on the proposed runtime side, conversely, if a program 21 executed by the proposed runtime 35 reads and writes to a variable, it may become read-only to the programs 22 on the PLC Runtime 30. These checks may be done statically at program start-up using knowledge of the IO used by the respective programs.

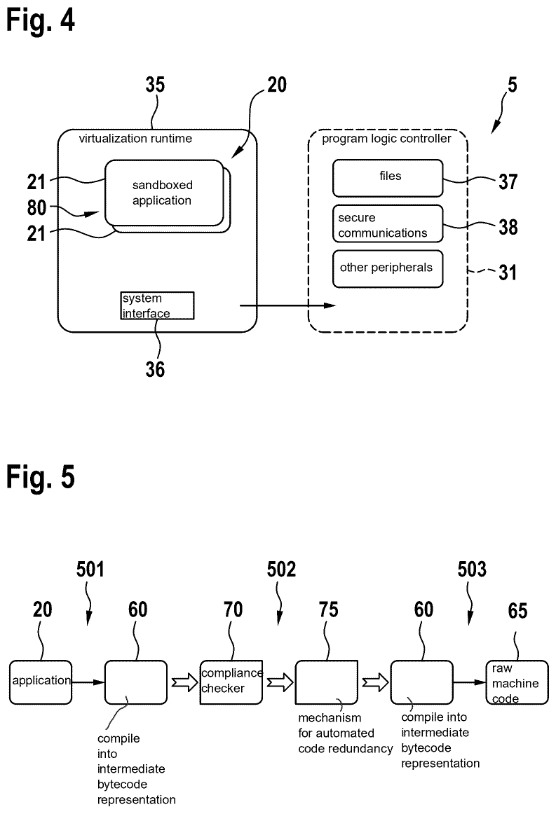

Embodiments of the present invention may provide a sandbox 80 for intermediate bytecode representations of a program 20 like Wasm. The sandbox 80, particularly Wasm sandbox, may guarantee software fault isolation between several PLC programs 20. Furthermore, embodiments of the present invention may provide a custom dispatcher that uses the underlying OS 40 to provide real time guarantees to the programs 20 under its execution. By leveraging Wasm support for multiple languages, the proposed runtime 35 can easily bring a multitude of programming languages into PLC development. The runtime environment according to embodiments of the present invention may provide programs 20 with access to several system facilities previously unavailable in common PLC programming environments: files 37, secure communication, 38 and other peripherals. This access may be provided by a system interface 36 provided by embodiments of the present invention which is designed with industrial platforms in mind (see FIG. 4).

According to embodiments of the present invention, programs 20 executed by the proposed runtime 35 may be compiled into an intermediate bytecode representation like WASM 60 and undergo code analysis and transformations to check and enforce program properties, inject monitoring and assertions to enforce properties and generate different program versions to be executed redundantly.

The system interface 36 according to embodiments of the present invention may allow programs 20 to access system resources on the PLC platform such as IO, files, peripheral devices, or communication interfaces. It can be designed in the same vein as the Wasm System Interface (WASI) around the concept of capabilities and provides access to resources in an industrial control system 5 by given programs 20 an unforgeable reference to an object/resource and a set of operations that the capability entitles the holder. FIG. 4 presents a detail of the system interface and how it interacts with programs and the PLC host system.

According to embodiments of the present invention, a code generation process may be provided that is shown in FIG. 5. For example, programs 20 may be written in any Wasm-supported language to be compiled 501 into Wasm bytecode. Code may then be analysed 502 to enforce that the program 20 can be transformed into a program compliant to the proposed runtime. This step can be necessary to ensure that programs 20 can meet real time performance and do not include unbounded recursion or loops. Regarding recursion and loops, programs may require including declarations that provide bounds like pragma instructions supported by some compilers. In this step 503, addition performance counters and traps may be inserted into the code to monitor the performance of the program at runtime and control its execution in case of an exception. This step might also include generating multiple program versions.

When enabled, the toolchain according to embodiments of the present invention can generate multiple versions of a program that can be executed in the runtime. These programs may have defined IO (provided by the system Interface) and execute with a defined structure, like a scan cycle (implemented by a library for the program development) that defines a clear point where IO can be compared (at the end/start of each cycle). The proposed runtime 35 may be responsible for checking if the several versions of the program 20 produced the same result and act according to a developer-specified policy, such as majority voting, min, max, or execution of an exception handler again specified by the developer.

To generate different versions of the PLC program 20, the proposed runtime 35 may resort to three strategies. The first strategy is to perform address space randomization. The second strategy is to perform code obfuscation that transforms the code, keeping it functionally equivalent. Together, these will allow to probabilistically detect memory handling faults as well as program manipulation attacks. The third strategy is applicable with heterogeneous compute engines (e.g., comprising μCs and μPs). This creates diverse redundancy, and the execution of the PLC program is also protected against systematic HW errors.

Embodiments of the present invention may be used for a middleware for Industrial Automation. Furthermore, embodiments of the present invention may be used for edge-cloud orchestration in industrial automation and/or specialized safety checking software for applications deployed in industrial automation and/or specialized automated code redundancy software for applications deployed in industrial automation and/or industrial automation platforms/ecosystem such as ctrlX World

The foregoing explanation of the embodiments describes the present invention in the context of examples. Of course, individual features of the embodiments can be freely combined with each other, provided that this is technically reasonable, without leaving the scope of the present invention.

1-10. (canceled)

11. A method for embedding at least one application in a real-time environment, the real-time environment being provided by a programmable logic controller, the method comprising the following steps:
receiving the at least one application, the at least one application being received as an intermediate representation;
providing a sandbox for the at least one received application;
executing the at least one sandboxed application, the executing being carried out based on an interpretation of the at least one sandboxed application using a virtualization runtime of the real-time environment, the intermediate representation being augmented by the runtime to provide at least one real-time and/or safety function for the at least one sandboxed application.

12. The method of claim 11, wherein the intermediate representation is a bytecode.

13. The method of claim 12, wherein the bytecode is WebAssembly.

14. The method of claim 11, wherein the augmentation of the intermediate representation by the runtime includes injecting monitoring and/or assertion code into the intermediate representation to provide the at least one real-time and/or safety function including to detect and prevent faults and attacks, wherein different versions of the sandboxed application are generated and executed redundantly.

15. The method of claim 11, wherein the runtime provides a multiprogramming environment for performing execution of multiple of the at least one sandboxed application at the same time.

16. The method of claim 15, wherein the runtime is configured to provide a software fault isolation between the at least one sandboxed application and further applications running in the real-time environment and/or between the multiple sandboxed applications.

17. The method of claim 15, wherein a system interface is provided to allow the at least one sandboxed application a controlled access to resources in an industrial control system.

18. The method of claim 11, wherein multiple versions of the at least one sandboxed application are executed by the runtime, a runtime voting mechanism being provided to check results of the multiple versions to provide redundancy of the at least one sandboxed application.

19. The method of claim 11, wherein the at least one sandboxed application is a safety-relevant application for automatically controlling a vehicle.

20. A non-transitory computer-readable medium on which is stored a computer program instructions for embedding at least one application in a real-time environment, the real-time environment being provided by a programmable logic controller, the instructions, when executed by a computer, causing the computer to perform the following steps:
receiving the at least one application, the at least one application being received as an intermediate representation;
providing a sandbox for the at least one received application;
executing the at least one sandboxed application, the executing being carried out based on an interpretation of the at least one sandboxed application using a virtualization runtime of the real-time environment, the intermediate representation being augmented by the runtime to provide at least one real-time and/or safety function for the at least one sandboxed application.

21. A data processing apparatus, comprising:
an arrangement for embedding at least one application in a real-time environment, the real-time environment being provided by a programmable logic controller, the arrangement configured to:
receive the at least one application, the at least one application being received as an intermediate representation;
provide a sandbox for the at least one received application;
execute the at least one sandboxed application, the executing being carried out based on an interpretation of the at least one sandboxed application using a virtualization runtime of the real-time environment, the intermediate representation being augmented by the runtime to provide at least one real-time and/or safety function for the at least one sandboxed application.

1. A method (100) for embedding at least one application (20) in a real-time environment, the real-time environment being provided by a programmable logic controller (31), comprising the following steps:
Receiving (101) the at least one application (20), the at least one application (20) being received as an intermediate representation,
Providing (102) a sandbox (80) for the at least one received application (20),
Executing (103) the at least one sandboxed application (21), the executing (103) being carried out based on an interpretation of the at least one sandboxed application (21) using a virtualization runtime (35) of the real-time environment, the intermediate representation being augmented by the runtime (35) to provide at least one real-time and/or safety function for the at least one sandboxed application (21).

2. The method (100) of claim 1, characterized in that the intermediate representation is a bytecode, particularly WebAssembly.

3. The method (100) of any one of the preceding claims, characterized in that the augmentation of the intermediate representation by the runtime (35) comprises injecting monitoring and/or assertion code into the intermediate representation to provide the at least one real-time and/or safety function, particularly to detect and prevent faults and attacks, wherein preferably different versions of the sandboxed application (20) are generated and executed redundantly.

4. The method (100) of any one of the preceding claims, characterized in that the runtime (35) provides a multiprogramming environment for performing the execution of multiple of the at least one sandboxed application (20) at the same time.

5. The method (100) of any one of the preceding claims, characterized in that the runtime (35) is configured to provide a software fault isolation between the sandboxed application (21) and further applications (20) running in the real-time environment and/or between the multiple sandboxed applications (21).

6. The method (100) of any one of the preceding claims, characterized in that a system interface (36) is provided to allow the sandboxed application (21) a controlled access to resources in an industrial control system (5).

7. The method (100) of any one of the preceding claims, characterized in that multiple versions of the sandboxed application (21) are executed by the runtime (35), a runtime (35) voting mechanism being provided to check results of the multiple versions, particularly to provide redundancy of the sandboxed application (21).

8. The method (100) of any one of the preceding claims, characterized in that the sandboxed application (21) is configured as a safety-relevant application (20), particularly for automatically controlling a vehicle (3).

9. A computer program (20), comprising instructions which, when the computer program (20) is executed by a computer, cause the computer to carry out the method (100) of any one of the preceding claims.

10. A data processing apparatus (10), comprising means for carrying out the method (100) of any one of claims 1 to 8.
